(19) United States
(12) Patent Application Publication
(10) Pub. No.: US 2018/0031067 A1
(43) Pub. Date: Feb. 1, 2018

(54) FRICTION MATERIAL AND FRICTION MEMBER

(71) Applicant: JAPAN BRAKE INDUSTRIAL CO., LTD., Hachioji-shi, Tokyo (JP)

(72) Inventors: Mitsuo UNNO, Hachioji-shi (JP); Masamichi MITSUMOTO, Koganei-shi (JP); Kazuaki MATSUBA, Hino-shi (JP)

(73) Assignee: JAPAN BRAKE INDUSTRIAL CO., LTD., Hachioji-shi, Tokyo (JP)

(21) Appl. No.: 15/549,318

(22) PCT Filed: Feb. 5, 2016
(86) PCT No.: PCT/JP2016/053501

§ 371 Date: Aug. 7, 2017

(30) Foreign Application Priority Data
Feb. 6, 2015 (JP) 2015-022169
Feb. 20, 2015 (JP) 2015-031224

(51) Int. Cl. F16D 69/02; F16D 65/00; F16D 65/092

(52) U.S. Cl. CPC F16D 69/026; F16D 65/092; F16D 65/0025; F16D 69/04

(57) ABSTRACT

The friction material and friction member are provided, in which copper, having serious environmental effects, is not contained or is not contained at more than 0.5 mass % of copper, rust adhering force is low, rust delamination is unlikely to occur, the friction material composition includes a binder, an organic filler, an inorganic filler, and a fibrous substrate, wherein the friction material composition contains no copper as an element or contains not more than 0.5 mass % of copper, and contains fibrillated aramid fiber as the fibrous substrate, and wherein porosity measured by oil immersing method is not more than 15% and sulfate ion concentration measured by ion chromatography is not more than 500 ppm.

### TECHNICAL FIELD

The present invention relates to a friction material such as disk brake pad used for braking of vehicles or the like, and in particular, relates to a nonasbestos friction material not containing asbestos. Furthermore, the present invention relates to a friction member which is formed by combining the friction material and a backing metal.

### BACKGROUND ART

Friction materials such as for disk brake pads, braking linings or the like are used for braking of vehicles or the like. The friction material functions in braking by producing friction on a facing material such as disk rotor, braking drum or the like. Therefore, a superior friction coefficient, abrasion resistance (long service life of friction material), strength, sound and vibration properties (braking noises and abnormal noises are difficult to generate) and the like are required for the friction material. The friction coefficient is required to be reliable regardless of vehicle velocity, deceleration and braking temperature. In addition, there may be a case in which the friction material adheres to the facing material by rust generated at a friction interface, and problems such as abnormal noises at starting of driving, surface delamination of the friction material (rust delamination) and the like occur. In order to solve the problem of adhesion due to rust, a friction material composition is proposed in which zinc functioning as a sacrificial anode or an alkaline metal salt increasing pH is added (see Patent Documents 1 and 2).

In the friction material, a friction material composition containing binder, fibrous substrate, inorganic filler, organic filler and the like is used, and in order to exhibit the abovementioned properties, a friction material composition containing one or more kinds selected from the above ingredients is generally used. In particular, copper is added to a friction material in the form of fiber or powder, and is an effective component for maintaining friction coefficient under braking conditions at high temperatures (anti-fade property), improving abrasion resistance at high temperatures, and improving strength of friction material. However, a friction material containing copper may generate abrasion powder containing copper during braking, and it may be a cause of contamination of rivers, lakes and oceans. Therefore, there is a tendency to limit use of copper.

Under recent circumstances limiting use of copper, the following Patent Document 3 discloses a technique of adding potassium titanate having multiple convex portions and biodegradable inorganic fiber as a method to improve strength and abrasion resistance in a composition not containing copper.

The Patent Documents are as follows:

Patent Document 1: Japanese Unexamined Patent Application Publication No. 2001-107026

Patent Document 2: Japanese Unexamined Patent Application Publication No. 2001-107027

Patent Document 3: Japanese Unexamined Patent Application Publication No. 2013-076058.

The friction material not containing copper that is harmful to the environment has low material strength, and there is a problem of rust delamination. The rust-proofing effect proposed in the Patent Documents 1 and 2 and the strength improving technique of friction material in a composition not containing copper proposed in the Patent Document 3 are not sufficient to improve effects against rust delamination of the friction material not containing copper.

### SUMMARY OF THE INVENTION

The present invention was completed in view of the above circumstances, and an object of the present invention is to provide a friction material in which rust adhering and rust delamination are low even in a friction material containing no copper that is harmful to the environment or containing copper at not more than 0.5 mass %.

The inventors have researched in order to achieve an object of reducing rust adhering force and rust delamination from the viewpoints of strength of friction material and restraining effect of rust and interaction between rust and friction material, in a composition containing fibrillated aramid fibers in order to improve material strength of the friction material and not containing copper. As a result, the inventors have found that it is effective for porosity measured by an oil immersing method to be not more than 15% and sulfate ion concentration measured by an ion chromatography to be not more than 1000 ppm. That is, the inventors have found that by containing fibrillated aramid fiber and making porosity not more than 15%, strength of friction material may be sufficiently high, and not only may rust delamination be unlikely to occur, but also rust may be unlikely to enter into pore of the friction material due to its low porosity. Furthermore, the inventors have found that by containing fibrillated aramid fiber, making porosity not more than 15%, and additionally, reducing sulfate ion concentration, it becomes possible to improve the corrosion resistance effect in addition to the abovementioned effects, and that rust adhering and rust delamination are greatly reduced even in a friction material not containing copper.

The friction material of the present invention based on the above knowledge includes a binder, an organic filler, an inorganic filler, and a fibrous substrate, wherein the friction material does not contain copper as an element, or contains not more than 0.5 mass % of copper, the fibrous substrate contains fibrillated aramid fiber, porosity measured by an oil immersing method is not more than 15%, and sulfate ion concentration measured by ion chromatography is not more than 1000 ppm (the first aspect of the invention).

In addition, as a result of further research to achieve the abovementioned object, the inventors have found that it is effective not to perform scorching treatment during the production process. That is, the inventors have found that generation of rust due to organic acid derived from a thermal decomposed material of the binder on the surface of the friction material is restrained by not performing scorching treatment. Furthermore, the inventors have found that porosity on the surface of the friction material is increased by performing scorching treatment, porosity on the surface of the friction material is not increased by not performing scorching treatment, and therefore, in the latter case, since the friction material strength is also increased, superior properties can be exhibited by a synergetic effect with the improvement effect of rust adhering and rust delamination.

The friction material of the present invention based on the above knowledge includes a binder, an organic filler, an inorganic filler, and a fibrous substrate, wherein the friction material contains no copper as an element, or contains not more than 0.5 mass % of copper, the fibrous substrate contains fibrillated aramid fiber, and a scorching treatment is not performed (the second aspect of the invention).

Furthermore, the inventors have found that in the friction material obtained without performing scorching treatment as above, in a case in which hardness is measured by employing one of Rockwell hardness R scale (HRR) or Rockwell hardness S scale (HRS) in which a hardness value measured is within a range of 50 to 90, a difference between a hardness value measured by the scale at surface of the friction material and a hardness value measured by the scale at a new surface portion after 2 mm from the original surface is removed is not more than 5 points, and that difference between an amount of mass reduction in a thermogravimetric analysis on a surface sample collected from a range of 1 mm from the surface and an amount of mass reduction in a thermogravimetric analysis on an interior sample collected from a range of 2 to 3 mm from the surface.

The friction material of the present invention based on the above knowledge includes a binder, an organic filler, an inorganic filler, and a fibrous substrate, wherein the friction material contains no copper as an element, or contains not more than 0.5 mass % of copper, the fibrous substrate contains fibrillated aramid fiber, and in a case in which hardness is measured by employing one of Rockwell hardness R scale (HRR) or Rockwell hardness S scale (I-IRS) in which a hardness value measured is within a range of 50 to 90, a difference between a hardness value measured by the scale at surface of the friction material and a hardness value measured by the scale at a portion of a new surface after 2 mm from the original surface is removed is not more than 5 points (the third aspect of the invention).

Furthermore, the friction material of the present invention based on the above knowledge includes a binder, an organic filler, an inorganic filler, and a fibrous substrate, wherein the friction material contains no copper as an element, or contains not more than 0.5 mass % of copper, the fibrous substrate contains fibrillated aramid fiber, and difference between an amount of mass reduction in a thermogravimetric analysis on a surface sample collected from a range of 1 mm from the surface and an amount of mass reduction in a thermogravimetric analysis on an interior sample collected from a range of 2 to 3 mm from the surface is not more than 5% (the fourth aspect of the invention).

In the second to fourth aspects of the invention, it is desirable that porosity measured by an oil immersing method be not more than 15% and sulfate ion concentration measured by an ion chromatography be not more than 1000 ppm.

In addition, the inventors have found the following knowledge in the first to fourth aspects of the invention. That is, by adding a specific amount of zinc powder exhibiting rustproofing action as a sacrificial anode and calcium hydroxide and/or sodium carbonate increasing pH of the friction material effectively, improvement effect on rust adhering and rust delamination can be further improved. Furthermore, by adding a specific amount of steel fiber which improves the friction material strength and reduces amount of rust generated, or by adding potassium titanate having multiple convex portions which improves the friction material strength, improvement effect of rust adhering and rust delamination can be improved further. Furthermore, improvement effect of rust adhering and rust delamination can be improved further by making the pH of the friction material in a range of 12 to 13.

Base on this knowledge, in the first to fourth aspects of the invention, it is desirable that the inorganic filler contain zinc powder, contain 2.5 to 10 mass % of calcium hydroxide, contain 0.2 to 2 mass % of sodium carbonate, and contain potassium titanate having multiple convex portions. It is desirable that the fibrous substrate contain 2 to 8 mass % of steel fiber. It is desirable that the pH be in a range of 12 to 13.

A friction member of the present invention is formed by each of the abovementioned friction materials of the present invention and a backing metal.

According to the present invention, the friction material and friction member can be provided, in which rust adhering force and rust delamination are low even if copper harmful to the environment is not used, when they are used for friction materials such as for brake pads or the like for vehicles.

### BRIEF DESCRIPTION OF DRAWINGS

FIG. 1 is a conceptual diagram showing a measuring method of surface hardness and interior hardness of a friction material.

FIG. 2 is a conceptual diagram showing a collecting method of a surface sample and an interior sample of a friction material used in thermogravimetric analysis.

FIG. 3A is a plan view showing one example of a brake pad (friction member) according to the one embodiment of the present invention, FIG. 3B is a cross sectional view along A-A in FIG. 3A in a case in which an adhesive layer having a specific thickness is not arranged, and FIG. 3C is a cross sectional view along A-A in FIG. 3A in a case in which adhesive layer of a specific thickness is arranged.

### EXPLANATION OF REFERENCE NUMERALS

1: brake pad (friction member)
2: friction material
22: slit
23: chamfer
3: backing metal
4: adhesive layer

### BEST MODE FOR CARRYING OUT THE INVENTION

Hereinafter, the friction material and the friction member of the present invention are explained in detail. It should be noted that the friction material of the present invention is a so-called non-asbestos friction material that does not contain asbestos substantially.

### [Friction Material]

The friction material of the present invention contains no copper as an element, or if copper is contained, contains not more than 0.5 mass %. That is, copper and a copper alloy, which are harmful to the environment, are not substantially contained, and the content amount of copper as an element in the friction material is not more than 0.5 mass %, desirably 0 mass %. As a result, even in a case in which abrasion powder is generated during braking, contamination will not occur in rivers, lakes, and oceans. It should be noted that “copper as an element” means content ratio of copper element contained in copper, copper alloy and copper compound in the form of fiber, powder or the like in the entire friction material.

Hereinafter components contained in the friction material according to the first to fourth aspects of the invention and conditions are explained.

### (Fibrillated Aramid Fiber/Fibrous Substrate)

The fibrillated aramid fiber contained as the fibrous substrate in the friction material of the present invention has multiple branched portions and BET specific surface area of 5 to 15 m²/g. Practically, Twaron 1099, 1095, 3091 produced by TEIJIN LIMITED, Kevlar 1F538, 1F1710 produced by DU PONT TORAY CO., LTD. and the like can be mentioned. Since the fibrillated aramid fiber used in the present invention has high fiber strength and numerous branched portions, friction material strength can be effectively improved even in a composition not containing copper and it is appropriate for a fibrous substrate of the friction material.

### (Porosity)

In the present invention, porosity in the friction material is defined (the first aspect of the invention), or porosity is alternatively added as a desirable embodiment (the second to fourth aspects of the invention). In both cases, the porosity is one measured by an oil immersing method and is not more than 15%. The porosity measured by the oil immersing method here is a porosity measured according to the Japanese Industrial Standards (JIS) D4418, and means a ratio of opening pores, not including ratio of closed pores. Since the porosity is lower in the friction material of the present invention, strength may be sufficient even in a composition not containing copper, and rust adhering force can be reduced and rust delamination can be restrained by preventing rust from entering into pores of the friction material. The porosity of the friction material can be controlled during a production process, and in particular, it can be easily controlled during a forming process by controlling forming pressure, forming temperature and forming time. Practically, the porosity can be reduced by increasing forming pressure and forming temperature and elongating forming time.

In a case in which porosity of a disk brake pad (friction member) in which friction material and backing metal are unified is measured, the friction material part and the backing metal are cut and separated, and the porosity of the friction material part can be measured by oil immersing method. It is desirable that the friction material part that is measured be not less than 5 mm from friction surface.

### (Sulfate Ion)

If sulfate ion concentration of the friction material is higher, rust is more likely to be generated on the friction material. Therefore, in the present invention, sulfate ion concentration is defined (the first aspect of the invention) or sulfate ion concentration is alternatively added as a desirable embodiment (the second to fourth aspects of the invention). In both cases, the sulfate ion concentration is one measured by ion chromatography and is not more than 1000 ppm. It is desirable that sulfate ion concentration measured by ion chromatography be not more than 500 ppm since rust may be less likely to be generated. In order to enable reducing sulfate ion concentration in the friction material, with respect to titanate salts, cashew dust or the like among materials which are used in an ordinary friction material, in which sulfuric acid is used in its production process, a kind containing little sulfate ion can be used. For example, as the titanate salt containing little sulfate ion, TOFIX (trade name) or the like produced by Toho Material Co., Ltd., can be mentioned. In addition, as the titanate salt containing little sulfate ion, FF1700 (trade name) or the like produced by Tohoku Chemical Industries, Ltd., can be mentioned.

Sulfate ion concentration in the friction material can be measured by the following steps. 20 g of pure water is added to the 3.0 g of the friction material, heated and extracted at 130° C. for 3 hours. After cooling, extracted liquid is filtered, solid phase extraction is performed and dilution is performed appropriately so as to obtain sample solution. Using ion chromatography, sulfate ion concentration of this sample solution is quantitatively measured by a standard curve method using sulfate ion standard solution.

Hereinafter one example of measuring condition of ion chromatography is shown.

Detecting device: electrical conductivity detecting device Column: inorganic anion exchange column (trade name: IonPac AS12A or the like, produced by DIONEX)

Eluent: 2.7 mmol/l of Na₂CO₃+0.3 mmol/l of NaHCO₃

Flow rate: 1.33 ml/min

Injection amount: 25 μl

Quantitative method: From peaks in which retention time is the same between a sulfate ion standard solution and a sample solution in ion chromatography, detecting amount is measured by the standard curve method.

### (Scorching Treatment)

In the second aspect of the invention, scorching process is not performed in its production process. Ordinarily, scorching treatment in which a surface of a friction material is treated at a high temperature not less than the decomposition temperature of phenol resin is performed on a friction material used for disk brake pad primarily for the purpose of improving braking at high temperature. However, since phenol resin at a surface of the friction material may be decomposed by scorching treatment, porosity at the surface of the friction material may be increased and rust may be more likely to enter into the interior of the friction material via pores, and in addition, rust is more likely to be generated by organic acid which is generated by heat decomposing of phenol resin. Therefore, by not performing such scorching treatment, rust is prevented from being generated, which is from organic acid derived from heat decomposed material of phenol resin on the surface of the friction material. Furthermore, increasing of porosity by scorching treatment on the surface of the friction material is prevented, and rust adhering force and rust delamination can be effectively restrained. In this way, by not performing scorching treatment, porosity at the surface is almost similar to porosity inside of the friction material, and rust is less likely to be generated.

It should be noted that an ordinary friction material is obtained as follows: raw material of friction material composition is preliminarily formed and the preliminarily formed material is thermally formed, or raw material of the friction material composition is directly thermally formed; the thermally formed material is heat treated; and treatment such as coating, processing and/or scorching is performed so as to obtain a product. Therefore, in order to check whether the friction material made by heat treatment of the thermally formed material is treated by scorching treatment or not, conditions of the surface of the friction material and the interior of the friction material are compared. That is, since the condition of the surface of the friction material and the interior of the friction material are not changed to be different from each other by coating or processing other than scorching treatment, it is obvious that there is an effect of scorching if the condition of surface of the friction material and inside of the friction material are different.

Such variation of a surface of the friction material and the interior of the friction material can be checked by comparing hardness of surface of the friction material and hardness in the interior of the friction material. That is, since phenol resin at the surface is thermally decomposed in the friction material which was processed by scorching treatment as explained above, hardness at the surface of the friction material may be reduced compared to hardness in the interior of the friction material where effects due to the heating of the scorching treatment is low. Here, hardness is measured by one of R scale (HRR) and S scale (HRS) of Rockwell hardness, and a scale in which hardness value measured is in a range of 50 to 90 is used. In both scales, it is undesirable to measure a difference in hardness, if the hardness value measured is outside the range of 50 to 90, because difference of hardness value measured is less likely to be exhibited even if there is a substantial difference.

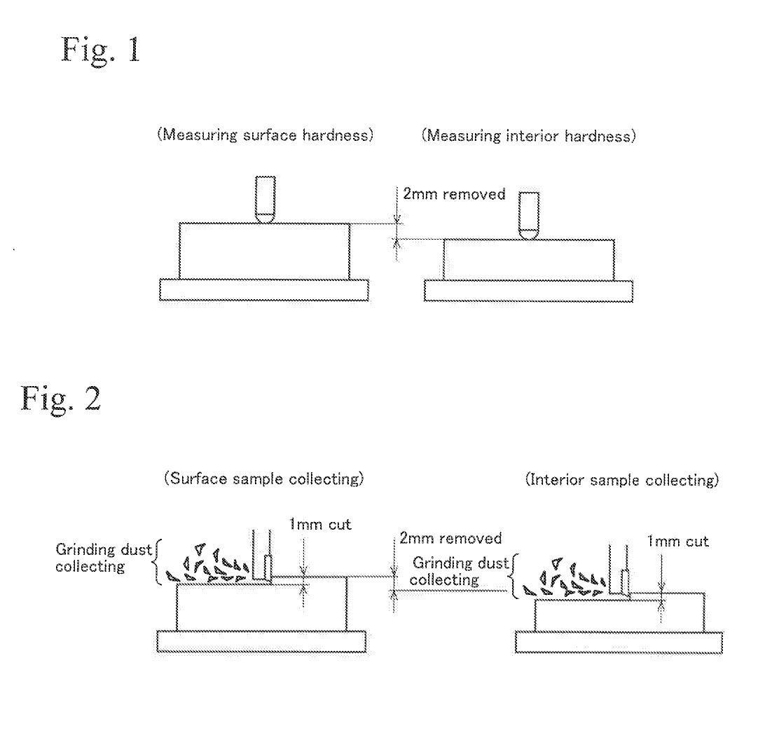

As a method to measure hardness at the surface and the interior, the following method can be employed: as shown in FIG. 1, hardness of the surface (surface hardness) corresponding to friction surface of a new final product of the friction material (left side in FIG. 1) which is not used yet is measured; a portion of 2 mm from the friction surface is removed in the friction material; hardness of new surface (interior hardness) of the friction material after removing (right side in FIG. 1) is measured. If the difference between the surface hardness and the interior hardness measured as mentioned above is not less than 5 points, it can be determined that scorching treatment was not performed.

In addition, variation of condition between surface of the friction material and inside of the friction material by scorching treatment can also be known from difference of amount of mass reduction in the Thermogravimetric Analysis (TG) using a sample (surface sample) collected from the surface of the friction material which is the new final product, and sample (interior sample) collected from the interior of the same friction material.

That is, in the friction material which is new final product, is not used yet and is processed by scorching treatment, since there is already a thermal history by scorching treatment on the surface, the amount of mass reduction may be smaller in the thermogravimetric analysis of the surface sample collected from the surface. On the other hand, the amount of mass reduction may be larger in the thermogravimetric analysis of the interior sample collected from the inside of the friction material since influence by scorching treatment is low. Therefore, when the thermogravimetric analysis is performed, in a case in which there is a difference between the amount of mass reduction of the surface sample containing surface part of the friction material and the amount of mass reduction of the interior sample containing an interior part of the friction material, it can be known that there is a thermal history on the surface of the friction material during the production process, and it is determined that scorching treatment was performed. On the other hand, there is no large thermal history at the surface of the friction material of which scorching treatment was not performed. Therefore, in a case in which there is no difference or almost no difference between the amount of mass reduction in the thermogravimetric analysis of the surface sample and the amount of mass reduction of the interior sample, it can be determined that scorching treatment was not performed.

The left part of FIG. 2 shows a condition in which a range of 1 mm depth from the surface of the friction material which is a new final product and is not yet used is ground and grinding dust that is generated is collected so that the surface sample is obtained. In addition, the right part of FIG. 2 shows a condition in which a range of 2 mm depth from the surface of the same friction material is ground, range of a further 1 mm depth from the new surface after removing 2 mm is ground and grinding dust that is generated is collected so that the interior sample is obtained. That is, the interior sample is grinding dust that is generated by grinding the range of 2 to 3 mm depth from the surface of the new friction material. The thermogravimetric analysis of the surface sample and the interior sample is performed, and amount of mass reduction at 400° C. of them are compared. If the difference between them is not more than 5%, it can be determined that scorching treatment was not performed on the friction material.

There is a case in which the friction material contains cashew dust or rubber component. Because decomposition starting temperature of these components is less than 400° C. and scorching treatment is generally performed at not less than 400° C., 400° C. is sufficient to compare the amount of mass reduction in the thermogravimetric analysis. In order to grind and collect the sample, a milling cutter, end mill or the like can be used. In a case in which the particle sizes of the collected ground sample are large, it is adjusted to an appropriate particle size for the thermogravimetric analysis using a mortar or the like.

The abovementioned thermogravimetric analysis can be performed by using Thermo plus EV0 TG8120 (trade name) or the like produced by Rigaku Corporation. It is desirable that the atmosphere be air, the measuring temperature range be 25 to 1000° C., and the temperature increase rate be 10° C./min as conditions of measuring. It is recommended that the amount of sample be 10 mg and that the sample container be made of aluminum.

In recent years, in order to improve fuel efficiency, the numbers of hybrid electric vehicles (HEVs) and electric vehicles (EVs) are increasing. In these vehicles, electricity is generated by converting kinetic energy to electrical energy by regenerative braking, and at the same time, the battery is charged by the generated electricity so as to reduce the amount of electricity consumed. In the power generation by the regenerative braking, since generation efficiency is high at a high velocity having high kinetic energy, braking at high velocity is performed by the regenerative braking and braking at low velocity at which generation efficiency is low and regenerative braking is unlikely to function is performed by a disk brake pad. In this way, since situations using disk brake pads at high velocity have been reduced, there is no problem if scorching treatment is abolished.

In the friction material of the present invention (the first to fourth aspects of the invention), as mentioned above, it is desirable that zinc powder be contained as the inorganic filler, 2.5 to 10 mass % of calcium hydroxide be contained as the inorganic filler, 0.2 to 2 mass % of sodium carbonate be contained as the inorganic filler, 2 to 8 mass % of steel fiber be contained as the fibrous substrate, potassium titanate having multiple convex portions be contained as the inorganic filler and pH be 12 to 13.

Hereinafter, these features are explained.

### (Zinc Powder/Inorganic Filler)

The powdered zinc contained as the inorganic filler in the friction material of the present invention may be in a condition in which it is ductilized on the friction interface of the friction material during braking and covers the friction interface. Since zinc is easily oxidized, zinc covering the friction interface is selectively oxidized by sacrificial anode action, and oxidization of other components in the friction material, that is, rust is prevented from occurring. Thus, rust is prevented from occurring on the entire friction interface. Therefore, if powdered zinc is contained in the friction material, rust adhering force can be further reduced and rust delamination can be further restrained. As the powdered zinc, powdered zinc which is produced by atomizing or the like and which has been used for an ordinary friction material composition can be used. From the viewpoint of rust proofing effect by ductilizing on the friction material surface, finer particle diameter is more desirable. It is desirable for it to be 10 to 500 μm and more desirably 10 to 100 μm. Furthermore, it is desirable that content amount of zinc be not less than 1 mass % from the viewpoint of rust proofing effect, and more desirable that it be 2 mass %. On the other hand, abrasion resistance of the friction material in use at high temperature may be deteriorated if excess amount of zinc is added. Therefore, the amount of zinc contained is desirably not more than 10 mass % and more desirable that it be 8 mass %.

### (Calcium Hydroxide, Sodium Carbonate/Inorganic Filler)

As the calcium hydroxide and sodium carbonate which are contained in the friction material of the present invention as the inorganic filler, powder calcium hydroxide and sodium carbonate which have been used for an ordinary friction material composition can be used. Furthermore, from the viewpoint of water solubility, powder calcium hydroxide and sodium carbonate having finer particle diameter are desirable, and in particular, it is desirable to use powder of not more than 100 μm. Calcium hydroxide and sodium carbonate not only have rust proofing effect of the friction facing material, but it also functions as a hardening catalyst of phenol resin during formation of the friction material and improves strength of the friction material. However, since strength of fibrillated aramid resin may be reduced if excess amount of them is added, it is desirable that content amount of calcium hydroxide be 2.5 to 10 mass % and content amount of sodium carbonate be 0.2 to 2 mass %. One of calcium hydroxide and sodium carbonate can be added or both of them simultaneously can be added to the friction material of the present invention.

As the abovementioned calcium hydroxide and sodium carbonate, powder calcium hydroxide and sodium carbonate which have been used for an ordinary friction material composition can be used. Furthermore, from the viewpoint of water solubility, powder calcium hydroxide and sodium carbonate having finer particle diameter are desirable, and in particular, it is desirable to use powder of not more than 100 μm.

### (Steel Fiber/Fibrous Substrate)

As the steel fiber which is desirable to be contained as the fibrous substrate in the friction material composition of the present invention, a straight fiber which can be produced by a chatter vibration cutting method or the like and a curled fiber which can be produced by cutting of long fiber or the like can be mentioned. The straight fiber has a linear fiber shape, and the curled fiber has a curved shape. Regardless of the straight fiber and the curled fiber, this kind of steel fiber not only disperses friction heat on the friction interface and restrains uneven temperature increase, but it also has an effect of appropriately cleaning decomposed organic material that is generated on the friction interface. Therefore, variation of braking torque occurring during braking can be reduced and braking vibration can be restrained. It should be noted that the curled fiber is less likely to fall off the friction interface of the friction material, and it is desirable from the viewpoint of maintaining friction properties during braking at high temperature. Furthermore, as the curled fiber, a fiber having a portion in which the curvature radius is not more than 100 μm is more desirable since it adheres to the friction material more, and the friction material is less likely to fall off from the friction interface. As the curled steel fiber, commercially available steel fiber such as cut wool produced by NIHON STEEL WOOL Co., Ltd. or the like can be used.

The steel fiber improves strength of the friction material and reduces rust delamination; however, excessive addition may increase rust adhering force since the steel fiber itself becomes rusted. Therefore, the amount contained of the steel fiber 2 to 8 mass % can achieve both reducing of rust adhering force and restraining rust delamination. It is desirable that fiber diameter of the steel fiber be not more than 100 μm from the viewpoint of abrasion resistance at high temperature. Furthermore, it is desirable that fiber length of the steel fiber be not more than 2500 μm from the viewpoint of abrasion resistance at high temperature.

### (Potassium Titanate Having Multiple Convex Portions/Inorganic Filler)

In the friction material of the present invention, a titanate salt which has been used in an ordinary friction material can be used as the inorganic filler. Titanate salt contributes to reduce braking vibration and rotor abrasion amount during braking at high temperature in the composition not containing copper. As the titanate salt, it is desirable to use potassium titanate having multiple convex portions. The potassium titanate having multiple convex portions in the present invention means potassium titanate having indefinite shape in which multiple convex portions extend to random directions, and is known that it can be used as a friction controlling material (see Patent Document 3). Practically, “TerracessJP” produced by Otsuka Chemical Co., Ltd. can be mentioned.

Such potassium titanate having indefinite shape in which multiple convex portions extending in random directions is effective for improving strength of friction material due to its convex portions. In particular, it is effective to restrain rust delamination of the friction material composition of the present invention. It is desirable that amount of potassium titanate having multiple convex portions contained in the friction material composition of the present invention be 1 to 30 mass % from the viewpoint of restraining rust delamination, and more desirably 1 to 20 mass %.

### (pH of the Friction Material)

In the friction material of the present invention, it is desirable that the pH of the friction material be not less than 12 because a higher pH can further reduce rust adhering force and further restrain rust delamination. The pH of the friction material can be easily increased by containing a component that is alkaline when dissolved in water, such as calcium hydroxide, sodium hydroxide, sodium carbonate or the like. However, since strength of the abovementioned fibrillated aramid fiber is reduced by hydrolysis in exposure over a long period of time in an aqueous solution having high pH, it is desirable that the pH of the friction material be not more than 13. The pH of the friction material can be measured according to Japanese Automotive Standards Organization (JASO) C458-86.

Next, the binder, the organic filler and the inorganic filler and the fibrous substrate other than the above explanation are mentioned as follows.

### (Binder)

The binder is used for unifying the organic filler, the inorganic filler, the fibrous substrate and the like contained in the friction material together, and for imparting strength. The binder contained in the friction material of the present invention is not limited in particular, and a thermosetting resin, which is commonly used as a binder for friction material, can be used.

As such a thermosetting resin, for example, phenol resin; elastomer dispersed phenol resin such as acryl elastomer dispersed phenol resin and silicone elastomer dispersed phenol resin; modified phenol resin such as acryl-modified phenol resin, silicone-modified phenol resin, cashew-modified phenol resin, epoxy-modified phenol resin and alkylbenzene-modified phenol resin and the like can be mentioned. These resins can be used alone or in combination of two kinds or more. In particular, phenol resin, acryl-modified phenol resin, silicone-modified phenol resin, and alkylbenzene-modified phenol resin are desirable due to their superior heat resistance, formability and friction coefficient.

It is desirable that the amount of the binder contained in the friction material in the present invention be 5 to 20 mass %, and more desirably be 5 to 10 mass %. In the case in which the amount of the binder contained is 5 to 20 mass %, strength degradation of the friction material can be reduced. In addition, elasticity of the friction material is increased, that is, sound and vibration properties such as squeaking noises due to being harder can be reduced further.

### (Organic Filler Material)

The organic filler is added as a friction controlling material for improving sound and vibration properties, abrasion resistance and the like of the friction material. The organic filler contained in the friction material of the present invention is not particularly limited as long as the filler exhibits the abovementioned properties. Cashew dust, rubber component or the like, which is commonly used as an organic filler, can be used.

The cashew dust which is obtained by hardening cashew nut shell oil and breaking the hardened oil, and which is generally used as a friction material, can be selected.

As the rubber component, for example, acryl rubber, isoprene rubber, NBR (acrylonitrile-butadiene rubber), SBR (styrene-butadiene rubber), chlorinated butyl rubber, butyl rubber, silicone rubber or the like can be mentioned, and in addition, tire rubber or the like which is obtained from abandoned tires can be used as the rubber component. These types of rubbers may be used alone or in combination of two or more kinds.

It is desirable that the amount of the organic filler contained in the friction material in the present invention be 1 to 20 mass %, and more desirably be 1 to 10 mass % and further desirably be 3 to 8 mass %. In the case in which the content amount of the organic filler is 1 to 20 mass %, sound and vibration properties degradation due to harder friction material, such as squeaking, can be avoided. In addition, heat resistance degradation and strength degradation due to thermal history can be avoided.

### (Inorganic Filler Material)

The inorganic filler is added as a friction controlling agent for avoiding heat resistance degradation of the friction material and for improving abrasion resistance and friction coefficient. The inorganic filler contained in the friction material of the present invention is not limited in particular, as long as the filler is generally used as an inorganic filler for a friction material.

As the inorganic filler, for example, mica, tin sulfide, molybdenum disulfide, iron sulfide, antimony trisulfide, bismuth sulfide, zinc sulfide, calcium oxide, barium sulfate, coke, graphite, mica, vermiculite, calcium sulfate, talc, clay, zeolite, mullite, chromite, titanium oxide, magnesium oxide, silica, dolomite, calcium carbonate, magnesium carbonate, γ alumina, zirconium silicate, manganese dioxide, zinc oxide, cerium oxide, zirconia, iron oxide or the like can be used. These may be used alone or in combination of two or more kinds. Furthermore, in addition to the abovementioned potassium titanate having multiple convex portions, granular or tabular titanate can be used in combination. As the granular or tabular titanate, potassium 6-titanate, potassium 8-titanate, lithium potassium titanate, magnesium potassium titanate, sodium titanate or the like can be used.

It is desirable that content amount of the inorganic filler in the friction material in the present invention be 30 to 80 mass %, and more desirably be 40 to 70 mass % and further desirably be 50 to 60 mass %. In the case in which the content amount of the organic filler is 30 to 80 mass %, heat resistance degradation can be avoided, and balance of content amount of other components of the friction material may be desirable.

### (Fibrous Substrate)

The fibrous substrate functions as a support in the friction material. In the friction material in the present invention, inorganic fiber, metallic fiber, organic fiber, carbon type fiber or the like which is usually used as a fibrous substrate material can be selected, and these may be used alone or in combination of two or more kinds.

As the inorganic fiber, ceramic fiber, biodegradable ceramic fiber, mineral fiber, glass fiber, silicate fiber or the like may be used alone or in combination of two or more kinds. Among these inorganic fibers, biodegradable mineral fiber containing SiO₂, Al₂O₃, CaO, MgO, FeO, Na₂O or the like in freely chosen combination is desirable, and as a commercially available product, Roxul series produced by LAPINUS FIBERS B.V or the like may be mentioned.

The metallic fiber is not limited in particular as long as it is usually used in a friction material, for example, other than zinc powder mentioned above, fiber of elemental metal or alloy other than copper and copper alloy such as aluminum, iron, tin, titanium, nickel, magnesium, silicon or the like, and fibers of cast iron, that is, fibers mainly containing metal can be used.

As the organic fiber, other than the fibrillated aramid fiber mentioned above, aramid fiber not having branching such as chopped aramid fiber or the like, cellulose fiber, acryl fiber, phenol resin fiber or the like may be used alone or in combination of two or more kinds.

As the carbon type fiber, flameproofed fiber, pitch type carbon fiber, PAN type carbon fiber, activated carbon fiber or the like may be used alone or in combination of two or more kinds.

It is desirable that the amount of the fibrous substrate contained in the friction material in the present invention be 5 to 40 mass %, and more desirably be 5 to 20 mass %, and furthermore desirably be 5 to 15 mass %. In the case in which the content amount of the organic filler is 5 to 40 mass %, appropriate porosity as a friction material is obtained, squeaking is avoided, appropriate material strength is obtained, abrasion resistance is exhibited, and superior formability is obtained.

The friction material of the present invention can be produced by a forming method using the abovementioned friction material composition of the present invention containing the binder, organic filler, inorganic filler and fibrous substrate, and can be employed as a friction material such as for a disk brake pad, braking lining or the like of vehicles. The friction material of the present invention can be produced by a commonly known forming method using the friction material composition of the present invention, and desirably by a heating pressing forming method.

In detail, for example, the friction material is produced by the following method in which the composition is uniformly mixed by using a mixing apparatus such as Loedige (trademark) mixer, pressing kneader or Eirich (trademark) mixer; the mixture is preliminary formed in a forming mold; the preliminarily formed material obtained is formed at a forming temperature of 130 to 160° C., forming pressure of 20 to 50 MPa, and forming time of 2 to 10 minutes; and the formed material obtained is heat treated at 150 to 250° C. for 2 to 10 hours. Furthermore, if necessary, coating, polishing treatment or the like is performed.

### [Friction Member]

The friction member of the present invention is made as the member having the above friction material as a friction surface. As the friction member, for example, one of the following structures can be mentioned.

(1) A structure having only the friction material.
(2) A structure having a backing metal and the friction material of the present invention arranged on the backing metal as a friction surface.
(3) A structure having a primer layer and an adhesive layer between the backing metal and the friction material in addition to the structure of (2), wherein the primer layer is for a purpose of surface modification of the backing metal for improving adhesive effect of the backing metal, and the adhesive layer is for a purpose of adhesion between the backing metal and the friction material.

The backing metal is usually used as a friction member to improve mechanical strength of the friction member. As material of the backing metal, metal or fiber reinforced plastic or the like, particularly iron, stainless steel, inorganic fiber reinforced plastic, carbon fiber reinforced plastic or the like may be mentioned. As the primer layer and the adhesive layer, one which is usually used in a friction member such as brake shoe may be selected.

Not only can the friction material of the present invention be used as an overlay material such as for a disk brake pad or brake lining of vehicles since the friction material has low rust adhesion force and rust delamination, but it can also be formed and used as an underlay material of a friction member. It should be noted that the overlay material means a friction material corresponding to a friction surface of a friction member, and the underlay material means a layer which exists between a friction material corresponding to a friction surface of a friction member and a backing metal and which has a purpose for improving shear strength, crack resistance or the like around an adhesive portion of the friction material and the backing metal.

### [Embodiment of the Friction Member/Brake Pad]

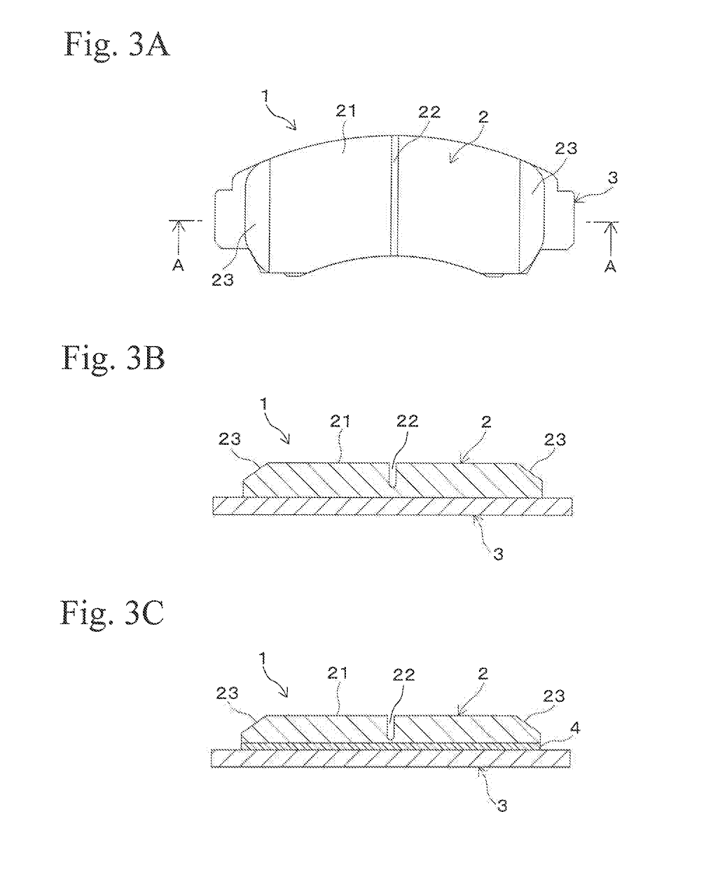

FIGS. 3A to 3C show a brake pad 1 of disk brake for vehicles which is the friction member according to one embodiment of the present invention. This brake pad 1 is constructed by adhering a friction material 2 formed into tabular shape onto one surface of a tabular backing metal 3 made of cast iron. Surface 21 of the friction material 2 corresponds to a friction surface which is pressed and contacted to a disk rotor (not shown) which is a facing material. The entire brake pad 1 is formed in the shape of an arc so as to fit a circumferential direction of the disk rotor. At the central part of circumferential direction on the surface 21 side of the friction material 2, a slit 22 extending along radial direction is formed. At the both edge parts of the circumferential direction, chamfers 23 are formed.

The friction material 2 is formed with the abovementioned friction material composition. The brake pad 1 has a structure (2) or (3) which is explained in the above [Friction member]. FIG. 3B is a cross sectional view showing the structure (2). FIG. 3C is a cross sectional view showing the structure (3), and reference numeral 4 is an adhesive layer having a specific thickness arranged between the friction material 2 and the backing metal 3.

The brake pad 1 is produced as follows; the above raw material composition is preliminarily formed as the friction material 2; the preliminarily formed friction material is adhered to the backing metal 3; heating pressing forming is performed to the adhered friction material and backing metal; a necessary treatment (heat treatment, coating, polishing treatment and the like) is performed; and the slit 22 and the chamfers 23 are formed on the friction material 2.

### EXAMPLES

Hereinafter, the friction material and friction member of the present invention are further explained in detail by way of Examples and Comparative Examples; however, the present invention is not limited thereto.

### Examples 1 to 16 and Comparative Examples 1 to 8

### (Preparation of Friction Material Sample and Disk Brake Pad Sample)

Each of the materials was added in an addition ratio shown in Tables 1 and 2, friction material composition of Examples 1 to 7 and Comparative Examples 1 to 4 were obtained. In addition, each of the materials was added in an addition ratio shown in Tables 3 and 4, friction material composition of Examples 8 to 16 and Comparative Examples 5 to 8 were obtained. The addition ratio in the Tables 1 to 4 is shown in mass %.

The friction material composition of Examples 1 to 16 and Comparative Examples 1 to 8 were mixed by a Loedige mixer (trade name: Loedige Mixer M20, produced by MATSUBO Corporation), and the mixtures obtained were preliminarily formed by a forming press (produced by Oji Machine Co., Ltd). Then, the preliminarily formed materials obtained were formed as it was while being heated and pressed so as to obtain friction material samples of Examples 1 to 16 and Comparative Examples 1 to 8, which consisted of only the friction material. On the other hand, the preliminarily formed materials obtained were formed while being heated and pressed together with an iron backing metal (produced by Hitachi Automotive Systems, Ltd.) so as to obtain disk brake pad samples of Examples 1 to 16 and Comparative Examples 1 to 8 in which the friction material is fixed to the backing metal. The above heating pressing forming was performed using a forming press (produced by SANKI SEIKO CO., LTD.) at a forming temperature of 140 to 160° C., at a forming pressure of 15 to 45 MPa and for a forming time of 3 to 10 minutes. It should be noted that the disk brake pad samples had thickness of the backing metal of 6 mm, thickness of the friction material of 11 mm, and projected area of the friction material of 52 cm².

Then, the friction material samples and the disk brake pad samples obtained were heat treated at 200° C. for 4.5 hours, and were polished by using a rotary polishing apparatus. Then, the friction material samples and the disk brake pad samples of Examples 1 to 7 and Comparative Examples 1 to 4 were treated by scorching treatment, if necessary. As shown in Tables 3 and 4, scorching treatment was not performed in Examples 8 to 16 and Comparative Example 7, and scorching treatment was performed in Comparative Examples 5, 6, 8.

With respect to the friction material samples and disk brake pad samples of Examples 1 to 16 and Comparative Examples 1 to 8 which were produced as mentioned above, following measurement and evaluation were performed. The results are shown in Tables 3 and 4.

(1) Measuring of Porosity/Friction Material Samples were Used

It was measured by an oil immersing method according to Japanese Industrial Standards (JIS) D4418.

(2) Measuring of Sulfate Ion Concentration/Friction Material Samples were Used

Using an electrical conductivity detecting apparatus (trade name: ICS-2000) produced by DIONEX and an inorganic anion exchange column (trade name: IonPac AS12A) produced by DIONEX, ion chromatography of an eluent in which Na₂CO₃ of 2.7 mmol/l and NaHCO₃ of 0.3 mmol/l were mixed was obtained under conditions of flow rate: 1.33 ml/min and injection amount: 25 μl. Sulfate ion concentration of the eluent was determined by measuring detection amount of a peak which had the same retention time as ion chromatography of a sulfate ion standard solution by a standard curve method.

(3) Measuring of pH/Friction Material Sample was Used

Using a glass electrode type hydrogen ion concentration indicator (trade name: D-54) produced by HORIBA, Ltd., about 3.0 g of grinding dust collected from the friction material and 20 g of ultrapure water were put in a heat-resistant container made of polytetrafluoroethylene, heating and extraction was performed at 130° C. for 3 hours, the extracted solution was filtered after cooling, solid phase extraction was further performed to obtain a sample solution, and pH was measured after the sample solution was appropriately diluted.

### (4) Measuring of Hardness/Friction Material Sample was Used

Surface hardness of the friction surface of the friction material sample was performed, and then, a portion of 2 mm from the surface was ground and removed so that interior hardness, which is a hardness of a new surface after removal, was measured. Measurement of the hardness was performed using the R scale (HRR) of Rockwell hardness so that the measured value of the hardness was in a range of 50 to 90.

### (5) Measuring of Thermogravimetric Analysis/Friction Material Sample was Used

A portion within a range of depth 1 mm from the surface of the friction material sample was ground by an end mill and grinding dust generated was collected as a surface sample. Next, a portion within a range of depth 2 mm from the surface of a new friction material sample was ground and removed, and grinding dust was cleaned off in order to prevent contamination. Then, a portion within a range of depth 1 mm from surface after removing of the friction material sample was also ground by an end mill and grinding dust generated was collected as an interior sample. Each of the samples obtained was stirred in a mortar so as to control particle diameter in 100 μm, and 10 mg of the sample was put in a sample container made of aluminum, and thermogravimetric analysis was performed using Thermo plus EV0 TG8120 produced by RIGAKU Corporation in conditions that measuring atmosphere: air, measuring temperature range: 25 to 1000° C., and temperature increase rate: 10° C./min. With respect to the surface sample and the interior sample obtained in this way, difference between amount of the surface sample mass reduction at 400° C. and amount of the interior sample mass reduction at 400° C. was measured.

(6) Evaluation of Rust Adhering Force/Disk Brake Pad Samples were Used

The rust adhering test was performed according to “rust adhering test method” in Japanese Industrial Standards (JIS) D4414. A case in which the rust adhering force was less than 50 N was evaluated as “Good”, a case in which the rust adhering force was not less than 50 N and less than 100 N was evaluated as “Satisfactory” and a case in which the rust adhering force was not less than 100 N was evaluated as “Unsatisfactory”.

(7) Evaluation of Rust Delamination/Disk Brake Pad Samples were Used

After the rust adhering test, whether or not the rust delamination occurred in which surface of the friction material delaminated and was transferred to surface of disk rotor was observed. A case in which the rust delamination did not occur was evaluated as “Satisfactory” and a case in which the rust delamination occurred was evaluated as “Unsatisfactory”.

TABLE 1

| | | Examples | | | | | |
|---|---|---|---|---|---|---|---|
| | | 1 | 2 | 3 | 4 | 5 | 6 |
| Fibrillated aramid fiber (Twaron1095, produced by TEIJIN) | | 5 | 5 | 5 | 5 | 5 | 5 |
| Sodium carbonate (average particle diameter 20 μm) | | 0 | 0 | 0 | 0 | 1.5 | 0 |
| Calcium hydroxide (average particle diameter 20 μm) | | 1.5 | 1.5 | 1.5 | 4 | 4 | 1.5 |
| Steel fiber (“#0”, produced by GMT) | | 0 | 0 | 0 | 0 | 0 | 5 |
| Potassium titanate having multiple convex portions | | 0 | 0 | 0 | 0 | 0 | 0 |
| (TerracessJP, produced by Otsuka Chemical Co., Ltd.) | | | | | | | |
| Powdered zinc (average diameter 50 μm) | | 0 | 0 | 2 | 0 | 0 | 0 |
| Inorganic | Barium sulfate | 23.5 | 23.5 | 21.5 | 21 | 19.5 | 18.5 |
| filler | Tin sulfide | 5 | 5 | 5 | 5 | 5 | 5 |
| | Granular potassium titanate | 20 | 20 | 20 | 20 | 20 | 20 |
| | Zirconia (BR-QZ, produced by DAIICHI | 10 | 10 | 10 | 10 | 10 | 10 |
| | KIGENSO KAGAKU KOGYO CO., LTD.) | | | | | | |
| | Mica | 5 | 5 | 5 | 5 | 5 | 5 |
| | Graphite (T150, produced by TIMCAL) | 5 | 5 | 5 | 5 | 5 | 5 |
| Organic | Cashew dust | 5 | 5 | 5 | 5 | 5 | 5 |
| filler | Tire rubber powder | 5 | 5 | 5 | 5 | 5 | 5 |
| Binder | Phenol resin | 10 | 10 | 10 | 10 | 10 | 10 |
| Fibrous | Mineral fiber | 5 | 5 | 5 | 5 | 5 | 5 |
| substrate | Copper fiber | 0 | 0 | 0 | 0 | 0 | 0 |

| | | | | | | |
|---|---|---|---|---|---|---|
| Porosity (%) | 13 | 8 | 13 | 13 | 13 | 13 |
| Sulfate ion concentration (ppm) | 400 | 300 | 400 | 350 | 350 | 400 |
| pH of the friction material | 11.5 | 11.5 | 11.5 | 12.2 | 12.3 | 11.5 |
| Rust adhering force | Satisfactory | Satisfactory | Good | Good | Good | Good |
| Rust delamination | Satisfactory | Satisfactory | Satisfactory | Satisfactory | Satisfactory | Satisfactory |

TABLE 2

| | | Examples | Comparative Examples | | | |
|---|---|---|---|---|---|---|
| | | 7 | 1 | 2 | 3 | 4 |
| Fibrillated aramid fiber (Twaron1095, produced by TEIJIN) | | 5 | 5 | 5 | 5 | 5 |
| Sodium carbonate (average particle diameter 20 μm) | | 0 | 0 | 0 | 0 | 0 |
| Calcium hydroxide (average particle diameter 20 μm) | | 1.5 | 1.5 | 1.5 | 1.5 | 1.5 |
| Steel fiber (“#0”, produced by GMT) | | 0 | 0 | 0 | 0 | 0 |
| Potassium titanate having multiple convex portions | | 20 | 0 | 0 | 0 | 0 |
| (TerracessJP, produced by Otsuka Chemical Co., Ltd.) | | | | | | |
| Powdered zinc (average diameter 50 μm) | | 0 | 0 | 0 | 0 | 0 |
| Inorganic | Barium sulfate | 23.5 | 23.5 | 13.5 | 23.5 | 23.5 |
| filler | Tin sulfide | 5 | 5 | 5 | 5 | 5 |
| | Granular potassium titanate | 0 | 20 | 20 | 20 | 20 |
| | Zirconia (BR-QZ, produced by DAIICHI | 10 | 10 | 10 | 10 | 10 |
| | KIGENSO KAGAKU KOGYO CO., LTD.) | | | | | |
| | Mica | 5 | 5 | 5 | 5 | 5 |
| | Graphite (T150, produced by TIMCAL) | 5 | 5 | 5 | 5 | 5 |
| Organic | Cashew dust | 5 | 5 | 5 | 5 | 5 |
| filler | Tire rubber powder | 5 | 5 | 5 | 5 | 5 |
| Binder | Phenol resin | 10 | 10 | 10 | 10 | 10 |
| Fibrous | Mineral fiber | 5 | 5 | 5 | 5 | 5 |
| substrate | Copper fiber | 0 | 0 | 10 | 0 | 0 |

| | | | | | |
|---|---|---|---|---|---|
| Porosity (%) | 13 | 18 | 18 | 18 | 13 |
| Sulfate ion concentration (ppm) | 400 | 1500 | 1600 | 400 | 1500 |
| pH of the friction material | 11.5 | 11.5 | 11.5 | 11.5 | 11.5 |
| Rust adhering force | Good | Unsatisfactory | Satisfactory | Unsatisfactory | Unsatisfactory |
| Rust delamination | Satisfactory | Unsatisfactory | Satisfactory | Unsatisfactory | Unsatisfactory |

TABLE 3

| | | Examples | | | | | | |
|---|---|---|---|---|---|---|---|---|
| | | 8 | 9 | 10 | 11 | 12 | 13 | 14 |
| Fibrillated aramid fiber | | 5 | 5 | 5 | 5 | 5 | 5 | 5 |
| (Twaron1095, produced by TEIJIN) | | | | | | | | |
| Sodium carbonate | | 0 | 1 | 1 | 1 | 0 | 0 | 0 |
| (average particle diameter 20 μm) | | | | | | | | |
| Calcium hydroxide | | 1.5 | 1.5 | 1.5 | 8 | 1.5 | 1.5 | 1.5 |
| (average particle diameter 20 μm) | | | | | | | | |
| Steel fiber (“#0”, produced by GMT) | | 0 | 0 | 0 | 0 | 5 | 0 | 0 |
| Potassium titanate having multiple convex portions | | 0 | 0 | 0 | 0 | 0 | 15 | 0 |
| (TerracessJP, produced by Otsuka | | | | | | | | |
| Chemical Co., Ltd.) | | | | | | | | |
| Powdered zinc (average diameter 50 μm) | | 0 | 0 | 0 | 0 | 0 | 0 | 3 |
| Inorganic | Barium sulfate | 32.5 | 31.5 | 31.5 | 25 | 27.5 | 32.5 | 29.5 |
| filler | Antimony trisulfide | 5 | 5 | 5 | 5 | 5 | 5 | 5 |
| | Granular potassium titanate | 15 | 15 | 15 | 15 | 15 | 0 | 15 |
| | (average particle diameter 5 μm) | | | | | | | |
| | Zircon sand | 3 | 3 | 3 | 3 | 3 | 3 | 3 |
| | (average particle diamter 1 μm) | | | | | | | |
| | Mica | 8 | 8 | 8 | 8 | 8 | 8 | 8 |
| | Graphie (KS15, | 5 | 5 | 5 | 5 | 5 | 5 | 5 |
| | produced by TIMCAL) | | | | | | | |
| Organic | Cashew dust | 5 | 5 | 5 | 5 | 5 | 5 | 5 |
| filler | Tire rubber powder | 5 | 5 | 5 | 5 | 5 | 5 | 5 |
| Binder | Silicone rubber modified phenol resin | 10 | 10 | 10 | 10 | 10 | 10 | 10 |
| Fibrous | Mineral fiber | 5 | 5 | 5 | 5 | 5 | 5 | 5 |
| substrate | Copper fiber | 0 | 0 | 0 | 0 | 0 | 0 | 0 |

| | | | | | | | |
|---|---|---|---|---|---|---|---|
| Porosity (%) | 13 | 8 | 13 | 13 | 13 | 13 | 13 |
| Sulfate ion concentration (ppm) | 1500 | 1450 | 1500 | 1400 | 1500 | 1650 | 1500 |
| pH of the friction material | 11.5 | 12.0 | 12.0 | 12.4 | 11.5 | 11.5 | 11.5 |
| Scorching treatment | No | No | No | No | No | No | No |
| Difference of hardness between surface | 2 | 1 | 0 | 2 | 0 | 4 | 1 |
| and inside (HRR) | | | | | | | |
| Difference of mass reducing ratio between surface | 0.4 | 4.2 | 1.6 | 0.9 | 1.2 | 3.1 | 0.7 |
| and inside by thermogravimetric analysis (%) | | | | | | | |
| Rust adhering force | Satisfactory | Satisfactory | Good | Good | Good | Good | Good |
| Rust delamination | Satisfactory | Satisfactory | Satisfactory | Satisfactory | Satisfactory | Satisfactory | Satisfactory |

TABLE 4

| | | Examples | | Comparative Example | | | |
|---|---|---|---|---|---|---|---|
| | | 15 | 16 | 5 | 6 | 7 | 8 |
| Fibrillated aramid fiber | | 5 | 5 | 5 | 5 | 5 | 5 |
| (Twaron1095, produced by TEIJIN) | | | | | | | |
| Sodium carbonate (average particle diameter 20 μm) | | 0 | 0.5 | 0 | 0 | 0 | 0 |
| Calcium hydroxide (average particle diameter 20 μm) | | 1.5 | 5 | 1.5 | 1.5 | 1.5 | 1.5 |
| Steel fiber (“#0”, produced by GMT) | | 0 | 5 | 0 | 0 | 0 | 0 |
| Potassium titanate having multiple convex portions | | 0 | 15 | 0 | 0 | 0 | 0 |
| (TerracessJP, produced by Otsuka Chemical Co., Ltd.) | | | | | | | |
| Powdered zinc (average diameter 50 μm) | | 0 | 3 | 0 | 0 | 0 | 0 |
| Inorganic | Barium sulfate | 32.5 | 20.5 | 32.5 | 22.5 | 32.5 | 32.5 |
| filler | Antimony trisulfide | 5 | 5 | 5 | 5 | 5 | 5 |
| | Granular potassium titanate | 15 | 0 | 15 | 15 | 15 | 15 |
| | (average particle diameter 5 μm) | | | | | | |
| | Zircon sand | 3 | 3 | 3 | 3 | 3 | 3 |
| | (average particle diamter 1 um) | | | | | | |
| | Mica | 8 | 8 | 8 | 8 | 8 | 8 |
| | Graphie (KS15, produced by TIMCAL) | 5 | 5 | 5 | 5 | 5 | 5 |
| Organic | Cashew dust | 5 | 5 | 5 | 5 | 5 | 5 |
| filler | Tire rubber powder | 5 | 5 | 5 | 5 | 5 | 5 |
| Binder | Silicone rubber modified phenol resin | 10 | 10 | 10 | 10 | 10 | 10 |
| Fibrous | Mineral fiber | 5 | 5 | 5 | 5 | 5 | 5 |
| substrate | Copper fiber | 0 | 0 | 0 | 10 | 0 | 0 |

| | | | | | | |
|---|---|---|---|---|---|---|
| Porosity (%) | 13 | 8 | 18 | 18 | 18 | 13 |
| Sulfate ion concentration (ppm) | 300 | 300 | 1500 | 1500 | 1500 | 1500 |
| pH of the friction material | 11.5 | 12.3 | 11.5 | 11.5 | 11.5 | 11.5 |
| Scorching treatment | No | No | Done | Done | No | Done |
| Difference of hardness between surface | 2 | 1 | 10 | 17 | 3 | 15 |
| and inside (HRR) | | | | | | |
| Difference of mass reducing ratio between surface | 1.3 | 0.8 | 10.1 | 7.3 | 1.4 | 9.7 |
| and inside by thermogravimetric analysis (%) | | | | | | |
| Rust adhering force | Good | Good | Unsatisfactory | Satisfactory | Unsatisfactory | Unsatisfactory |
| Rust delamination | Satisfactory | Satisfactory | Unsatisfactory | Satisfactory | Unsatisfactory | Unsatisfactory |

According to Tables 1 and 2, in Examples 1 to 7 of the present invention, rust delamination did not occur and rust adhering force was low, in a manner that was similar to Comparative Example 2 containing copper. Furthermore, compared to Comparative Examples 1, 3 and 4 in which copper was not contained, fibrillated aramid fiber was contained and porosity and sulfate ion concentration did not satisfy the range of present invention, it was obvious that rust adhering force was low and rust delamination was difficult to occur in Examples 1 to 7 of the present invention.

According to Tables 3 and 4, in Examples 8 to 16 of the present invention, rust delamination did not occur and rust adhering force was low, in a manner similar to Comparative Example 6 containing copper. Furthermore, compared to Comparative Examples 5, 7 and 8 in which copper was not contained, fibrillated aramid fiber was contained, porosity did not satisfy the present invention and scorching treatment was performed, it was obvious that rust adhering force was low and rust delamination was difficult to occur in Examples 8 to 16 of the present invention.

By the friction material and the friction member of the present invention, rust adhering force is low and rust delamination is restrained compared to a conventional product without using copper which is harmful to the environment. Therefore, they are desirable for brake pad or the like for vehicles.

1. A friction material comprising:
a binder,
an organic filler,
an inorganic filler, and
a fibrous substrate,
wherein the friction material contains no copper as an element, or contains not more than 0.5 mass % of copper,
the fibrous substrate contains fibrillated aramid fiber,
porosity measured by an oil immersing method is not more than 15%, and
sulfate ion concentration measured by ion chromatography is not more than 1000 ppm.

2. A friction material comprising:
a binder,
an organic filler,
an inorganic filler, and
a fibrous substrate,
wherein the friction material contains no copper as an element, or contains not more than 0.5 mass % of copper,
the fibrous substrate contains fibrillated aramid fiber, and
a scorching treatment is not performed.

3. A friction material comprising:
a binder,
an organic filler,
an inorganic filler, and
a fibrous substrate,
wherein the friction material contains no copper as an element, or contains not more than 0.5 mass % of copper,
the fibrous substrate contains fibrillated aramid fiber, and
in a case in which hardness is measured by employing one of Rockwell hardness R scale (HRR) or Rockwell hardness S scale (HRS) in which hardness value measured is within a range of 50 to 90, difference between a hardness value measured by the scale at a surface of the friction material and a hardness value measured by the scale at a portion after 2 mm from the surface is removed is not more than 5 points.

4. A friction material comprising:
a binder,
an organic filler,
an inorganic filler, and
a fibrous substrate,
wherein the friction material contains no copper as an element, or contains not more than 0.5 mass % of copper,
the fibrous substrate contains fibrillated aramid fiber, and
difference between an amount of mass reduction in a thermogravimetric analysis on a surface sample collected from a range of 1 mm from the surface and an amount of mass reduction in a thermogravimetric analysis on an interior sample collected from a range of 2 to 3 mm from the surface is not more than 5%.

5. The friction material according to claim 2, wherein porosity measured by an oil immersing method is not more than 15%.

6. The friction material according to claim 2, wherein sulfate ion concentration measured by ion chromatography is not more than 1000 ppm.

7. The friction material according to claim 1, wherein the inorganic filler contains zinc powder.

8. The friction material according to claim 1, wherein the inorganic filler contains 2.5 to 10 mass % of calcium hydroxide.

9. The friction material according to claim 1, wherein the inorganic filler contains 0.2 to 2 mass % of sodium carbonate.

10. The friction material according to claim 1, wherein the fibrous substrate contains 2 to 8 mass % of steel fiber.

11. The friction material composition according to claim 1, wherein the inorganic filler contains potassium titanate having multiple convex portions.

12. The friction material according to claim 1, wherein pH is in a range of 12 to 13.

13. A friction member formed by the friction material according to claim 1 and a backing metal.

14. The friction material according to claim 3, wherein porosity measured by an oil immersing method is not more than 15%.

15. The friction material according to claim 3, wherein sulfate ion concentration measured by ion chromatography is not more than 1000 ppm.

16. The friction material according to claim 2, wherein the inorganic filler contains zinc powder.

17. The friction material according to claim 2, wherein the inorganic filler contains 2.5 to 10 mass % of calcium hydroxide.

18. The friction material according to claim 2, wherein the inorganic filler contains 0.2 to 2 mass % of sodium carbonate.

19. The friction material according to claim 2, wherein the fibrous substrate contains 2 to 8 mass % of steel fiber.

20. The friction material composition according to claim 2, wherein the inorganic filler contains potassium titanate having multiple convex portions.

21. The friction material according to claim 2, wherein pH is in a range of 12 to 13.

22. A friction member formed by the friction material according to claim 2 and a backing metal.

23. The friction material according to claim 4, wherein porosity measured by an oil immersing method is not more than 15%.

24. The friction material according to claim 4, wherein sulfate ion concentration measured by ion chromatography is not more than 1000 ppm.

25. The friction material according to claim 3, wherein the inorganic filler contains zinc powder.

26. The friction material according to claim 3, wherein the inorganic filler contains 2.5 to 10 mass % of calcium hydroxide.

27. The friction material according to claim 3, wherein the inorganic filler contains 0.2 to 2 mass % of sodium carbonate.

28. The friction material according to claim 3, wherein the fibrous substrate contains 2 to 8 mass % of steel fiber.

29. The friction material composition according to claim 3, wherein the inorganic filler contains potassium titanate having multiple convex portions.

30. The friction material according to claim 3, wherein pH is in a range of 12 to 13.

31. A friction member formed by the friction material according to claim 3 and a backing metal.

32. The friction material according to claim 4, wherein the inorganic filler contains zinc powder.

33. The friction material according to claim 4, wherein the inorganic filler contains 2.5 to 10 mass % of calcium hydroxide.

34. The friction material according to claim 4, wherein the inorganic filler contains 0.2 to 2 mass % of sodium carbonate.

35. The friction material according to claim 4, wherein the fibrous substrate contains 2 to 8 mass % of steel fiber.

36. The friction material composition according to claim 4, wherein the inorganic filler contains potassium titanate having multiple convex portions.

37. The friction material according to claim 4, wherein pH is in a range of 12 to 13.

38. A friction member formed by the friction material according to claim 4 and a backing metal.
